(19) United States
(12) Patent Application Publication
(10) Pub. No.: US 2019/0187286 A1
(43) Pub. Date: Jun. 20, 2019

(54) Sensor Apparatus for a Vehicle

(71) Applicant: Robert Bosch GmbH, Stuttgart (DE)

(72) Inventors: Dominik Jan Schott, Freiburg I.Br. (DE); Michael Baus, Bietigheim-Bissingen (DE); Remigius Has, Grafenau-Daetzingen (DE)

(21) Appl. No.: 16/309,511

(22) PCT Filed: Apr. 12, 2017
(86) PCT No.: PCT/EP2017/058760

§ 371 Date: Dec. 13, 2018

(30) Foreign Application Priority Data
Jun. 13, 2016 (DE) 10 2016 210 379.2

(51) Int. Cl. G01S 17/58; B60W 40/068; G01S 7/481

(52) U.S. Cl. CPC G01S 17/58; G01S 2013/936; G01S 7/4815; B60W 40/068

(57) ABSTRACT

A sensor apparatus for a vehicle, in particular a motor vehicle, includes at least one transmitter configured to emit a light beam with a predefinable wavelength, at least one receiver configured to sense the light beam when reflected by an object, and a device configured to determine a property of the object with respect to the sensed reflected light beam. The receiver has a sensor array configured to sense at least one of wavelengths and wavelength changes of the reflected light beams from at least two transmitters. The device is further configured to determine at least one surface quality of the object, and determine a speed of the sensor apparatus relative to the object with reference to the sensed at least one of wavelengths and wavelength changes.

The invention relates to a sensor apparatus for a vehicle, in particular a motor vehicle, having at least one transmitting unit for emitting a light beam having a predefinable wavelength, having at least one receiving unit for capturing the at least one light beam of the transmitting unit reflected on an object, and having a unit which determines at least one property with respect to the object in dependence on the captured reflected light beam.

Furthermore, the invention relates to a safety system for a vehicle, in particular a motor vehicle, having at least one sensor apparatus as described above, and having at least one actuator unit, which operates or is activated in dependence on a roadway condition captured by the sensor apparatus.

Furthermore, the invention relates to a method for operating the sensor apparatus or the safety system.

### PRIOR ART

Sensor apparatuses, safety systems, and methods of the type mentioned at the outset are known from the prior art. In particular in automotive engineering, taking into consideration a coefficient of friction of a roadway surface along which the motor vehicle moves is significant for the activation of actuators which are associated with, for example, a brake system or a vehicle safety system, in order to enhance the vehicle safety of the motor vehicle. Thus, for example, if a reduced coefficient of friction is established, a starting torque or a braking torque can be reduced in order to avoid the loss of adhesion of edges of the vehicle to the roadway surface. Scanning the roadway surface by means of an infrared sensor, which generates an infrared light beam oriented onto the roadway surface and receives the infrared light beam reflected on the roadway surface, is known in particular in this case for the coefficient of friction estimation.

### SUMMARY OF THE INVENTION

The sensor apparatus according to the invention having the features of claim 1 has the advantage that both items of information about the roadway condition and/or the surface, in particular the coefficient of friction of a surface of the roadway, and also items of information about the present driving speed are captured by the sensor apparatus. The sensor apparatus thus unifies the functionality of coefficient of friction sensors and speed sensors in a compact and cost-effective manner. According to the present invention, it is provided for this purpose that the receiver unit comprises a sensor array for capturing wavelengths or wavelength changes of the reflected light beam, and the unit is designed for the purpose of determining at least one surface condition of the object and a relative speed in relation to the object in dependence on the captured wavelengths and/or wavelength changes. By providing the sensor array, a driving speed can be captured in a simple manner. In this case, an analysis is substantially performed as is used, for example, in the case of computer mice having laser sensor and light granulation. By means of the sensor array, changes of the reflected light are tracked and the relative speed between the sensor apparatus and the object on which the light beam is reflected is determined from this tracking. In the present case, this is used for the purpose of ascertaining the driving speed of the vehicle, while the surface condition of the object, in particular the roadway, is monitored at the same time in dependence on captured wavelengths or wavelength changes of the reflected light.

According to one preferred refinement of the invention, it is provided that the unit is designed for the purpose of determining a coefficient of friction of the surface on which the light beam is reflected in dependence on the wavelengths and/or wavelength changes. A wavelength-dependent change of optical properties of the object or the roadway surface, respectively, is thus established by means of the sensor apparatus, in particular to capture the coefficient of friction of the surface.

Furthermore, it is preferably provided that the sensor comprises multiple transmitting units, of which at least two, in particular three generate light beams having different wavelengths. The transmitting units are designed differently insofar as they each generate a light beam having a wavelength which differs from the light beam of at least one further transmitting unit of the sensor. By emitting light beams having different wavelengths, in particular a redundant capture of the driving speed or the relative speed between sensor apparatus and driver or object, respectively, is ensured. In particular, it is provided that three transmitting units are provided, which each generate a light beam having a wavelength different from the other transmitting units. It is particularly preferably provided that the transmitting units are designed as infrared laser diodes, which generate an infrared light beam. The infrared laser diodes are usable cost-effectively and enable an accurate alignment of the light beam onto the object to be checked and/or monitored, in particular the roadway. It is particularly preferably provided that a first of the infrared laser diodes is designed to generate a light beam having a wavelength of λ₁=980 nm, a second of the laser diodes to generate a light beam having a wavelength of λ₂=1310 nm, and a third of the laser diodes to generate a light beam having a wavelength of λ₃=1550 nm. An advantageous capture of the roadway condition and/or the coefficient of friction of the surface of the object and a reliable speed ascertainment are ensured by the different wavelengths of the three light beams of the three infrared laser diodes selected in this manner.

Furthermore, it is preferably provided that the receiver unit is designed as an infrared broadband detector in order to capture the different wavelengths of the reflected light beams. A miniaturization of the sensor apparatus down to embedding in a single housing is possible in this way, which housing can be attached, for example, in the vicinity of the tire on the vehicle body of a motor vehicle in order to capture and take into consideration the coefficient of friction of the roadway surface for each tire individually. It is thus possible, for example, to determine the present slip and traction for each tire and to activate and/or set safety units of the motor vehicle accordingly, in order to handle the captured slip and traction.

The safety system according to the invention having the features of claim 7 is distinguished by the sensor apparatus according to the invention. The above-mentioned advantages result in this case. In particular, it is provided that the actuator unit is designed as a brake unit or as an ABS, ASR, or ESP device, which is activated in dependence on a present roadway condition to achieve an optimum driving result.

In particular, it is provided that at least two edges of the vehicle, in particular every wheel of the vehicle, are each associated with one of the sensor apparatuses to enable a wheel-individual determination and consideration of the roadway condition. In particular, the sensor apparatuses are arranged in front of the respective wheel viewed in the forward travel direction in order to capture the roadway condition of the roadway section which is located immediately in front of the respective wheel.

According to one preferred refinement of the invention, it is provided that the respective sensor apparatus is designed/situated for the purpose of guiding the respective light beam perpendicularly or nearly perpendicularly or at a predetermined angle onto the roadway. A simple variant of the sensor apparatus is implemented by the perpendicular or nearly perpendicular alignment, which minimizes the influence of vehicle vibrations and ground waviness in order to maintain the demand for a constant distance of the sensor apparatus in relation to a reference object or the roadway, respectively. By guiding the respective light beam at a predefined angle onto the roadway, in particular such that the light beam is oriented in the forward travel direction, the advantage is achieved that in spite of the close arrangement of the sensor apparatus in relation to the wheel, the roadway condition is ascertained in front of the wheel at a distance which ensures that the computation of the coefficient of friction of the roadway and/or the velocity and also the activation occurring therefrom of the actuator unit occurs before the wheel which is associated with the respective sensor apparatus reaches the point of the roadway which has been scanned by the sensor apparatus.

The method according to the invention having the features of claim 10 is distinguished in that a driving speed of the vehicle and a coefficient of friction of the roadway surface are ascertained in dependence on the captured wavelengths and/or wavelength changes of the reflected light and taken into consideration during the activation of the at least one actuator unit. The above-mentioned advantages result in this case. Further advantages and preferred features and feature combinations result in particular from the description above and from the claims.

The invention will be explained in greater detail hereafter on the basis of the drawing. In the figures

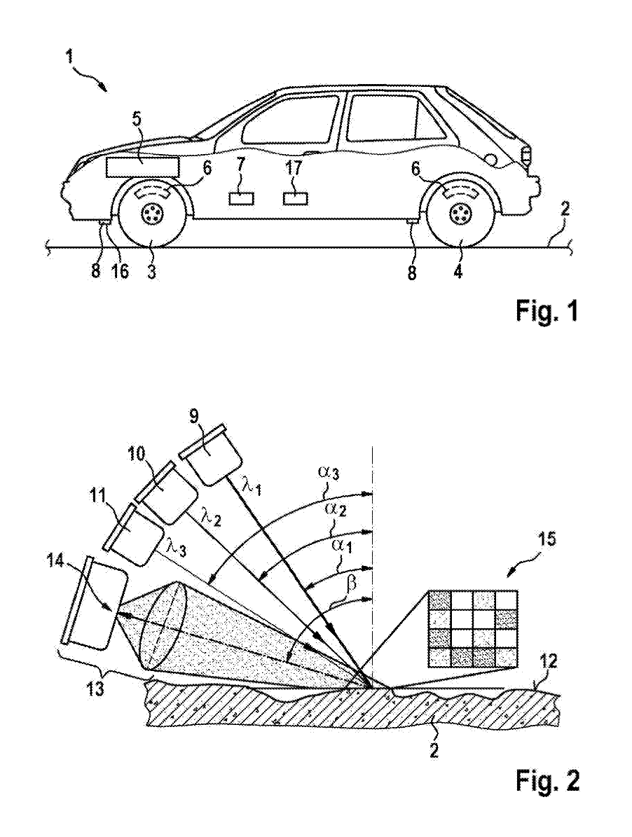

FIG. 1 shows a vehicle in a simplified side view,

FIG. 2 shows an advantageous sensor apparatus of a safety system of the vehicle in a simplified illustration, and

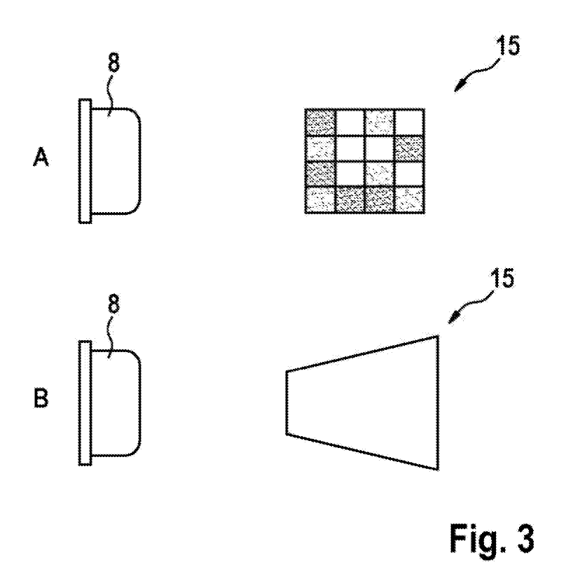

FIGS. 3A and 3B show different embodiments of the sensor apparatus.

FIG. 1 shows a simplified side view of a vehicle 1, which is located on a roadway 2. The vehicle 1 has two wheel axles each having two wheels 3, 4, of which at least the wheels 3, 4 of one of the wheel axles are drivable by a drive unit 5, which is designed in particular as an internal combustion engine or electric motor. Furthermore, one wheel brake unit 6 is associated with each of the wheels 3, 4. The wheel brake units 6 are integrated into a safety system 7, which is designed, for example, as an ABS, ESP, or ASR system and activates the wheel brake units 6 in dependence on a driver braking command or acceleration command and in dependence on a present adhesive friction between the wheels 3, 4 and the roadway 2.

According to the present exemplary embodiment, a sensor apparatus 8 is respectively associated with each of the wheels 3, 4, which is used to monitor the surface condition of the roadway 2 and a driving speed of the vehicle 1.

According to a further exemplary embodiment, it is preferably provided that the vehicle 1 only has one of the sensor apparatuses 8 or only two sensor apparatuses 8, wherein the two sensor apparatuses 8 are each associated with one wheel of a wheel axle.

FIG. 2 shows a simplified illustration of an advantageous design of the sensor apparatus 8. The sensor apparatus 8 comprises multiple transmitting units 9, 10, 11, which are each designed as infrared laser diodes and each generate a light beam having a predetermined wavelength λ₁, λ₂, and λ₃. The transmitting units 9, 10, 11 are aligned in this case such that the respective light beams are incident on the same point or nearly on the same point of the surface 12 of the roadway 2. In this case, the transmitting units 9, 10, 11 are aligned such that the light beams are incident diagonally on the surface 12, wherein in the present case the light beams of the sensor units 9, 10, 11 are incident at different angles α₁, α₂, and α₃ in relation to a perpendicular on the surface 12, wherein: α₁<α₂<α₃. In particular, the transmitting units 9 to 11 are aligned in this case such that the point of incidence of the light beams on the surface 12 of the roadway 2 in the forward travel direction is located in front of the transmitting units 9, 10, 11, and therefore the surface 12 of the roadway 2 present in front of the sensor apparatus in the travel direction is scanned. The receiving unit 13 is aligned in this case at an angle β in relation to the perpendicular on the roadway surface 12, which is greater than the angle α₃ according to the present exemplary embodiment.

Furthermore, the sensor apparatus 8 has a receiving unit 13, which comprises a sensor array 14 for capturing the light beams reflected on the surface 12. According to the present exemplary embodiment, the sensor array 14 has 4×4, i.e., a total of 16 receptors arranged in a matrix, which each capture one brightness value, as shown by way of example on the basis of a brightness distribution 15 illustrated in FIG. 2. A relative speed of the sensor apparatus 8 with respect to the roadway 2 is established by the tracking of the brightness distributions by the sensor array 14. This takes place, for example, on the basis of known image analysis algorithms.

Furthermore, the receiving unit is designed for the purpose of capturing the wavelengths λ₁, λ₂, and λ₃ and/or wavelength changes of the reflected light beams. The condition of the roadway surface 12, in particular with respect to its coefficient of friction, is ascertained as a function of the captured wavelengths or wavelength changes.

The sensor apparatus 8 thus unifies the functionality of coefficient of friction sensors and speed sensors. By using two or more of the infrared laser diodes to illuminate the reference object or, in the present case, the roadway surface 12 and the capture of the reflected light beams by means of the sensor array, in particular photodetector array, the wavelength-dependent changes of optical properties of the roadway surface are determinable. In addition, a redundancy of the speed ascertainment is ensured by the use of different wavelengths λ₁, λ₂, and λ₃. It is provided in the present case that the transmitting units 9, 10 and 11 generate infrared light beams having the wavelengths λ₁=980 nm, λ₂=1310 nm, and λ₃=1550 nm. The receiving unit 13 is designed in particular as an infrared broadband detector. The advantageous embodiment of the sensor apparatus 8 offers the option of miniaturization down to embedding in a single housing 16 which, as shown in FIG. 1, is attachable to the vehicle body of the vehicle 1, in particular to the lower side of the vehicle body of the vehicle 1. Simple retrofitting of the motor vehicle 1 or the safety system of the motor vehicle 1, respectively, is thus also possible. The installation of the sensor apparatus 8 enables the verification of slip and traction of each wheel 3, 4 and/or tire individually by direct measurement.

By taking into consideration the wavelengths or wavelength changes of the reflected light beams, it is also possible to differentia between wet, icy, snow-covered, and dry roadway surface 12, and therefore the safety system 7 can be activated accordingly and/or the ascertained coefficients of friction can be taken into consideration.

The configuration shown in FIG. 2 results in a nonlinear change of the image regions due to a trapezoidal projection onto the sensor array 14, which will be explained in greater detail on the basis of FIG. 3.

FIG. 3 shows two different embodiments of the sensor apparatus 8, wherein according to a first embodiment A, the sensor apparatus 8 is designed for the purpose of orienting the light beams perpendicularly onto the roadway surface 12, while according to the second embodiment B, the sensor apparatus is designed as shown in FIG. 2. Due to the inclined alignment of the transmitting units 9, 10, 11, a trapezoidal measurement field results, as shown in FIG. 3B. This distortion of the captured sensor data is preferably computed out during the analysis. To avoid this, the sensor apparatus 8 is alternatively designed such that the light beams are aligned perpendicularly in relation to the roadway surface 12 according to embodiment A, and therefore a square and/or undistorted measurement field results on the roadway surface 12. The perpendicular observation has the advantage that the influence of vehicle vibrations and ground waviness is minimized, and therefore the sensor apparatus 8 substantially maintains a constant distance in relation to the reference object, which facilitates the analysis of the captured data.

By way of the advantageous embodiment of the sensor apparatus 1 and/or the safety system of the motor vehicle 1, in particular coefficient of friction maps are produced for automated driving, which optimize, for example, an ACC function and/or an ESP, ABS, and/or ASR function by capturing the coefficient of friction data of the roadway surface 12. The captured coefficients of friction and/or the captured surface condition of the roadway 2 are additionally preferably relayed to other road users via radio or other data connection, for example, by means of vehicle-to-vehicle communication.

1. A sensor apparatus for a vehicle, comprising:
at least one transmitting unit configured to emit at least one light beam with a predefinable wavelength;
at least one receiving unit configured to capture the at least one light beam of the at least one transmitting unit reflected by an object; and
a unit configured to determine a property of the object with reference to the at least one captured reflected light beam, the receiving unit including a sensor array configured to capture at least one of wavelengths and wavelength changes of reflected light beams of at least two transmitting units wherein the unit is further configured to determine at least one condition of a surface the object and a speed of the sensor apparatus relative to the object with reference to the captured at least one of the wavelengths and wavelength changes.

2. The sensor apparatus as claimed in claim 1, wherein the unit is further configured to determine a coefficient of friction of the surface with reference to the captured at least one of the wavelengths and wavelength changes.

3. The sensor apparatus as claimed in claim 1, wherein:
the sensor apparatus comprises a plurality of transmitting units; and
at least two of the plurality of transmitting units are further configured to generate light beams having different wavelengths.

4. The sensor apparatus as claimed in claim 1, wherein the at least one transmitting unit is at least one infrared laser diode.

5. The sensor apparatus as claimed in claim 12, wherein the at least three transmitting units are at least three laser diodes configured to generate light beams having different wavelengths of λ₁=980 nm, λ₂=1310 and λ₃=1550 nm, respectively.

6. The sensor apparatus as claimed in claim 1, wherein the at least one receiving unit is an infrared broadband detector.

7. A safety system for a vehicle, comprising:
at least one sensor apparatus configured to capture a roadway condition, the at least one sensor apparatus including:
at least one transmitting unit configured to emit at least one light beam with a predefinable wavelength;
at least one receiving unit configured to capture the at least one light beam of the at least one transmitting unit reflected by an object; and
a unit configured to determine a property of the object with reference to the at least one captured reflected light beam, the receiving unit including a sensor array configured to capture at least one of wavelengths and wavelength changes of reflected light beams of at least two transmitting units, wherein the unit is further configured to determine at least one condition of a surface of the object and a speed of the sensor apparatus relative to the object with reference to the captured at least one of the wavelengths and wavelength changes; and
at least one actuator unit, which operates or activates in response to the roadway condition captured by the at least one sensor apparatus.

8. The safety system as claimed in claim 7, wherein a respective one of the at least one sensor apparatus is associated in each case with at least two wheels of the vehicle.

9. The safety system as claimed in claim 8, wherein the respective sensor apparatus at least one of configured and positioned such that the at least one light beam generated by the respective sensor apparatus is incident perpendicularly or nearly perpendicularly on the surface of the roadway or at an angle deviating from a perpendicular on the surface of the roadway.

10. A method for operating a sensor apparatus comprising:
emitting, with at least two transmitting unit of the sensor apparatus, at least two light beams with predefinable wavelengths;
capturing, with at least one receiving unit of the sensor apparatus, the at least two light beam of the at least two transmitting unit reflected by an object;
capturing, with a sensor array of the at least one receiving unit, at least one of wavelengths and wavelength changes of the at least two reflected light beams; and
determining, with the unit, a speed of the sensor apparatus relative to the object and a coefficient of friction of a surface of the object with reference to the captured at least one of wavelengths and wavelength changes of the at least two reflected light beams captured by the at least one receiving unit.

11. The sensor apparatus as claimed in claim 1, wherein the vehicle is a motor vehicle.

12. The sensor apparatus as claimed in claim 3, wherein at least three of the plurality of transmitting units are further configured to generate light beams having different wavelengths.

13. The safety system of claim 7, wherein the vehicle is a motor vehicle.

14. The safety system of claim 7, wherein a respective one of the at least one sensor apparatus is associated in each case with each wheel of the vehicle.
